(19) United States
(12) Patent Application Publication
(10) Pub. No.: US 2023/0269388 A1
(43) Pub. Date: Aug. 24, 2023

(54) ADAPTIVE BLOCK-BASED FRAME SIMILARITY ENCODING

(71) Applicant: QUALCOMM Incorporated, San Diego, CA (US)

(72) Inventors: Alec Matthew SHERAN, Pascoag, RI (US); Tate HORNBECK, Cambridge, MA (US)

(21) Appl. No.: 17/651,784

(22) Filed: Feb. 18, 2022

(51) Int. Cl. H04N 19/42; H04N 19/172; H04N 19/176; H04N 19/182; H04N 19/119; H04N 19/105; H04N 19/127; H04N 19/423; H04N 19/46

(52) U.S. Cl. CPC H04N 19/439; H04N 19/172; H04N 19/176; H04N 19/182; H04N 19/119; H04N 19/105; H04N 19/127; H04N 19/423; H04N 19/46

(57) ABSTRACT

Aspects presented herein relate to methods and devices for graphics processing including an apparatus, e.g., a GPU or CPU. The apparatus may divide a current frame of a plurality of frames into a plurality of blocks. The apparatus may also generate an encoding value representing data for each of the plurality of blocks in the current frame. Further, the apparatus may compare the encoding value representing the data for each block in the current frame with a previous encoding value representing previous data for a corresponding block in a previous frame. The apparatus may also store the data for at least one block in the current frame if the encoding value representing the data for the at least one block is not similar to the previous encoding value representing the previous data for at least one corresponding block in the previous frame.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform graphics processing. The apparatus may receive, from at least one component in a graphics processing unit (GPU) pipeline, a plurality of frames in a scene prior to dividing a current frame into a plurality of blocks. The apparatus may also divide a current frame into a plurality of blocks, the current frame being included in a plurality of frames in a scene, each of the plurality of blocks in the current frame including a set of pixels. Additionally, the apparatus may render, upon dividing the current frame into the plurality of blocks, each of the plurality of blocks in the current frame including the set of pixels. The apparatus may also generate, upon dividing the current frame into the plurality of blocks, an encoding value representing data for each of the plurality of blocks in the current frame. The apparatus may also compare the data for each of the plurality of blocks in the current frame with reference data for a reference block, where the comparison of the data with the reference data is associated with the generation of the encoding value representing the data for each of the plurality of blocks in the current frame. Moreover, the apparatus may compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene. The apparatus may also identify whether the encoding value representing the data for each of the plurality of blocks in the current frame is similar to the previous encoding value representing the previous data for the corresponding block of the plurality of blocks in the previous frame. Further, the apparatus may store the data for at least one block of the plurality of blocks in the current frame if the encoding value representing the data for the at least one block is not similar to the previous encoding value representing the previous data for at least one corresponding block of the plurality of blocks in the previous frame. The apparatus may also update the encoding value representing the data for the at least one block of the plurality of blocks in the current frame after the data for the at least one block is stored.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 is an example graphics processing unit (GPU).

FIG. 3 is a diagram illustrating an example image or surface used in graphics processing.

FIG. 4 is a diagram illustrating an example system memory and graphics memory (GMEM).

FIG. 5 is a diagram illustrating an example frame difference calculation process.

FIG. 6 is a diagram illustrating example GPU hardware components including a GMEM and a shader processor (SP).

FIG. 7 is a communication flow diagram illustrating example communications between GPU components and a memory.

FIG. 8 is a flowchart of an example method of graphics processing.

FIG. 9 is a flowchart of an example method of graphics processing.

### DETAILED DESCRIPTION

In some aspects of processing different frames in a scene, the amount of perceptible change between successive frames may be relatively unnoticeable (e.g., unnoticeable to the human eye). This may occur when the scene objects in successive frames stay somewhat stable or when a high frame rate or frames-per-second (FPS) is utilized. In aspects of frame detection, regions of successive frames with a small amount of change (i.e., little to no change) may be detected during different processing stages. If these types of regions are detected, then power saving countermeasures or time saving countermeasures may be deployed by a GPU. Some types of detection methods may be utilized to classify successive frames (or portions of successive frames) as similar or identical. However, relying on some detection methods (e.g., traditional hashing methods) to classify successive frames (or portions of successive frames) as strictly identical may yield methods that are too rigid and unforgiving. In some instances, it may be the case that a region with no human-discernable differences exists between successive frames, but there technically may be some small inconsequential differences in pixel value between the frames. Conventional hashing algorithms may consider these regions with small inconsequential differences as being different, and thus eliminate them from candidacy for identical regions. Additionally, in some aspects, there may be a certain specification or condition regarding the sizes of different blocks in a frame. This type of specification or condition may further exacerbate a lack of flexibility in the frame detection process. However, setting the dimensions in frames to be too large may result in a missed detection of these regions. Moreover, setting the dimensions in frames to be too small may also be undesirable, as unnecessary overhead may be introduced in sparsely populated regions of the frame that do not need the same level of granularity as other regions that are more populated. These types of problems may result in any potential power or time savings being unreachable. Aspects of the present disclosure may improve the amount of power savings or time savings in frame similarity detection or frame difference detection. In some instances, aspects presented herein may provide greater flexibility or optimization opportunities within frame similarity detection or frame difference detection. Moreover, aspects of the present disclosure may provide differently sized frame dimensions within a frame. For instance, aspects of the present disclosure may allow for differently sized blocks within a frame used in frame similarity detection or frame difference detection. Also, aspects of the present disclosure may preserve visual fidelity during the process of frame similarity detection or frame difference detection.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

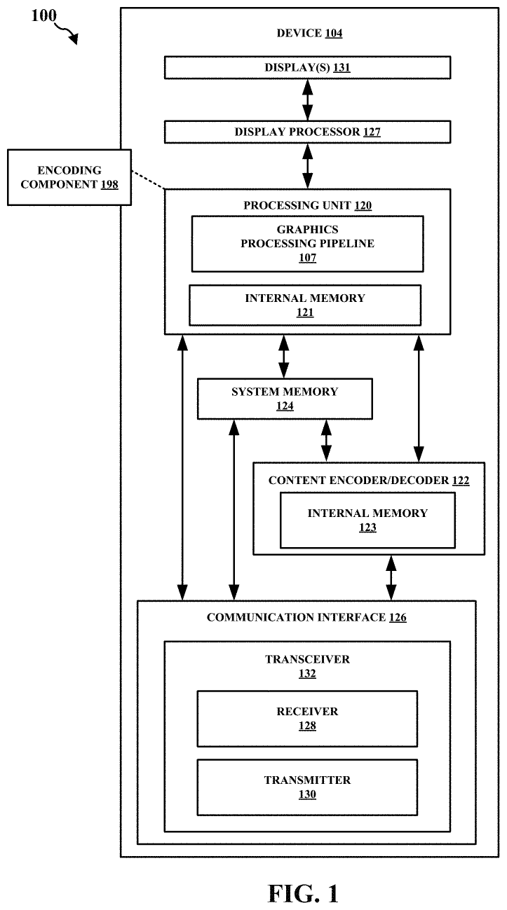

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an encoding component 198 configured to receive, from at least one component in a graphics processing unit (GPU) pipeline, a plurality of frames in a scene prior to dividing a current frame into a plurality of blocks. The encoding component 198 may also be configured to divide a current frame into a plurality of blocks, the current frame being included in a plurality of frames in a scene, each of the plurality of blocks in the current frame including a set of pixels. The encoding component 198 may also be configured to render, upon dividing the current frame into the plurality of blocks, each of the plurality of blocks in the current frame including the set of pixels. The encoding component 198 may also be configured to generate, upon dividing the current frame into the plurality of blocks, an encoding value representing data for each of the plurality of blocks in the current frame. The encoding component 198 may also be configured to compare the data for each of the plurality of blocks in the current frame with reference data for a reference block, where the comparison of the data with the reference data is associated with the generation of the encoding value representing the data for each of the plurality of blocks in the current frame. The encoding component 198 may also be configured to compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene. The encoding component 198 may also be configured to identify whether the encoding value representing the data for each of the plurality of blocks in the current frame is similar to the previous encoding value representing the previous data for the corresponding block of the plurality of blocks in the previous frame. The encoding component 198 may also be configured to store the data for at least one block of the plurality of blocks in the current frame if the encoding value representing the data for the at least one block is not similar to the previous encoding value representing the previous data for at least one corresponding block of the plurality of blocks in the previous frame. The encoding component 198 may also be configured to update the encoding value representing the data for the at least one block of the plurality of blocks in the current frame after the data for the at least one block is stored. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

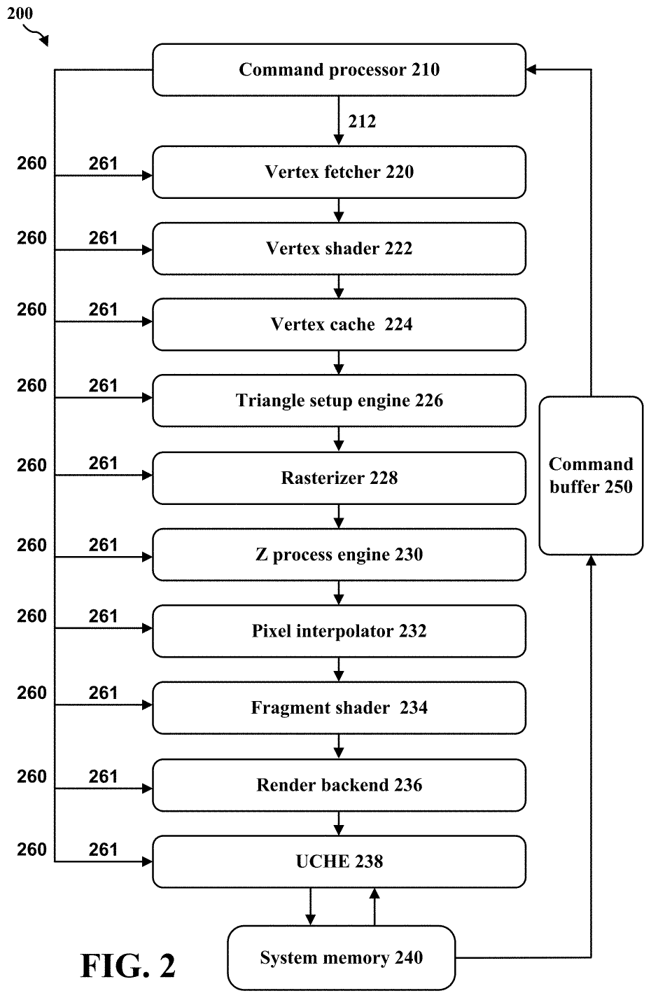

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

In some aspects of tiled rendering, there may be multiple processing phases or passes. For instance, the rendering may be performed in two passes, e.g., a visibility or bin-visibility pass and a rendering or bin-rendering pass. During a visibility pass, a GPU may input a rendering workload, record the positions of the primitives or triangles, and then determine which primitives or triangles fall into which bin or area. In some aspects of a visibility pass, GPUs may also identify or mark the visibility of each primitive or triangle in a visibility stream. During a rendering pass, a GPU may input the visibility stream and process one bin or area at a time. In some aspects, the visibility stream may be analyzed to determine which primitives, or vertices of primitives, are visible or not visible. As such, the primitives, or vertices of primitives, that are visible may be processed. By doing so, GPUs may reduce the unnecessary workload of processing or rendering primitives or triangles that are not visible. In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each of the primitives in each bin or area, e.g., in a system memory. This visibility information may be used to determine or generate a visibility stream. In a rendering pass, the primitives in each bin may be rendered separately. In these instances, the visibility stream may be fetched from memory used to drop primitives which are not visible for that bin.

Some aspects of GPUs or GPU architectures may provide a number of different options for rendering, e.g., software rendering and hardware rendering. In software rendering, a driver or CPU may replicate an entire frame geometry by processing each view one time. Additionally, some different states may be changed depending on the view. As such, in software rendering, the software may replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware may manage the replication or processing of the primitives or triangles for each viewpoint in an image.

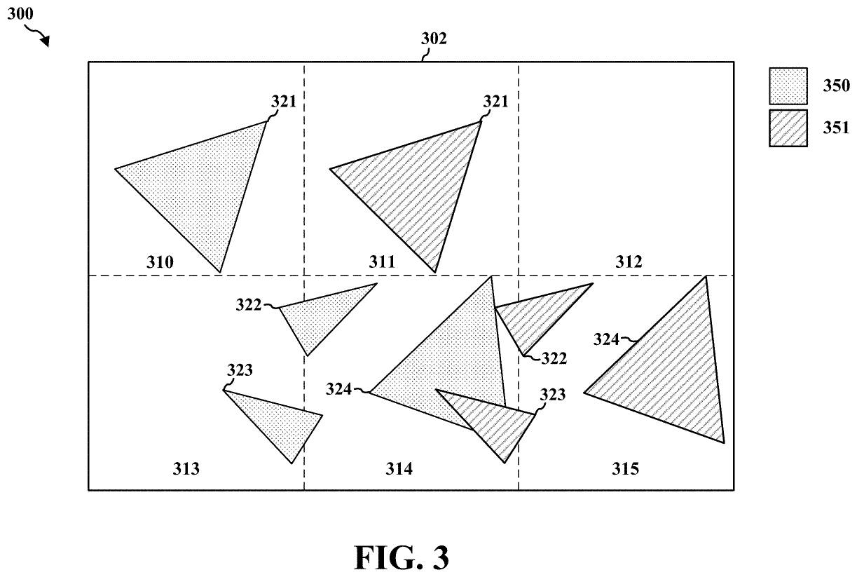

FIG. 3 illustrates image or surface 300, including multiple primitives divided into multiple bins. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 may utilize multiple viewpoints or multi-view rendering.

As indicated herein, GPUs or graphics processor units may use a tiled rendering architecture to reduce power consumption or save memory bandwidth. As further stated above, this rendering method may divide the scene into multiple bins, as well as include a visibility pass that identifies the triangles that are visible in each bin. Thus, in tiled rendering, a full screen may be divided into multiple bins or tiles. The scene may then be rendered multiple times, e.g., one or more times for each bin. In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM), e.g., containing a bitmap or storage, to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

Additionally, graphics applications may build or include multiple buffers, e.g., a depth buffer and/or a color buffer with a diffuse color. Also, graphics applications may build or include shadow maps, e.g., for light at the depth or color buffers. For instance, applications may run a renderer on one buffer, e.g., for a diffuse color, and then move to another buffer, e.g., to create a shadow for a different light. Graphics applications may also combine other information with previously saved information at buffers, e.g., a specular color and/or shadows on a previous color buffer. As indicated herein, in bin or tiled rendering architecture, frame buffers may have data stored or written to them repeatedly, e.g., when rendering from different types of memory. This may be referred to as resolving and unresolving the frame buffer or system memory. For example, when storing or writing to one frame buffer and then switching to another frame buffer, the data or information on the frame buffer may be resolved from the GPU internal memory (GMEM) at the GPU to the system memory, i.e., memory in the double data rate (DDR) RAM or dynamic RAM (DRAM).

In some aspects, the system memory may also be system-on-chip (SoC) memory or another chip-based memory to store data or information, e.g., on a device or smart phone. The system memory may also be physical data storage that is shared by the CPU and/or the GPU. In some instances, the system memory may be a DRAM chip, e.g., on a device or smart phone. Accordingly, SoC memory may be a chip-based manner in which to store data. In some aspects, the GMEM may be on-chip memory at the GPU, which may be implemented by static RAM (SRAM). Additionally, GMEM may be stored on a device, e.g., a smart phone. As indicated herein, data or information may be transferred between the system memory or DRAM and the GMEM, e.g., at a device. In some aspects, the system memory or DRAM may be at the CPU or GPU. Additionally, data may be stored at the DDR or DRAM. In bin or tiled rendering, a small portion of the memory may be stored at the GPU, e.g., at the GMEM. In some instances, storing data at the GMEM may utilize a larger processing workload and/or power consumed compared to storing data at the frame buffer or system memory.

As indicated herein, in bin or tiled rendering, there may be different types of memory storage, e.g., system or SoC memory and GMEM or on-chip memory, to store different data or information, e.g., the color or depth for a particular tile. In some aspects, the rendering data for each tile or bin may be transferred during an unresolve or resolve process. During the unresolve process, data or information may be moved from the system memory to the GMEM. Likewise, during the resolve process, data or information may be moved from the GMEM to the system memory. This process may then be repeated for the next bin or tile. In some aspects, GMEM or on-chip memory may have a limited data size. Accordingly, the process of transferring rendered information from the GMEM to the system memory or frame buffer may be performed on a tile-by-tile basis. For example, the GMEM may have a size to store colors of 256×256 pixels, which may correspond to the size of a tile. A frame buffer or system memory may have a larger data size compared to the size of the GMEM, e.g., may store colors of 1920×1080 pixels. In some aspects, when partitioning a frame buffer, e.g., 1920×1080 pixels, this may be performed in multiple steps based on the size of each tile, e.g., 256×256 pixels.

As mentioned above, when storing or writing data or information to the system memory or frame buffer, a tile or bin may be unresolved when moving data or information from the system memory to the GMEM. Also, a tile or bin may be resolved when moving data or information from the GMEM to the system memory. For example, the resolving process may transfer data or information the size of a tile, e.g., 256×256 pixels, to the system memory. Aspects of the present disclosure may then move to another tile and continue the unresolve/resolve process, such as by unresolving the tile from the system memory to GMEM, rendering the tile, and then resolving the tile from the GMEM to the system memory. This process may continue until the entire frame buffer is filled. As indicated herein, data for each tile may be moved from the system memory to the GMEM, i.e., the unresolve process, and then after rendering the data may be moved from the GMEM back to the system memory, i.e., the resolve process. Thus, the unresolve process may be an inverse movement of data compared to the resolve process. This unresolve/resolve process may be performed because the GPU memory or GMEM may be able to store less information compared to the system memory. So once rendered, tile data may be moved from the GMEM back to the frame buffer and stored on the system memory. As such, the rendered data for a tile may be transferred to the frame buffer on the system memory. Also, in some aspects, during the unresolve process, data stored at the frame buffer may be transferred to the GMEM when it is needed to render a tile at the GPU. Accordingly, a portion of the frame buffer data may be transferred from the system memory to the GMEM, and after rendering based on this data, the data may be transferred back to the frame buffer at the system memory. This process may be performed for each bin or tile until the entire surface is finished rendering.

Additionally, in some aspects, each tile may be rendered multiple rendering times, such that a portion of a tile is rendered. Accordingly, rendering data may be transferred multiple times back and forth between the system memory and the GMEM during the unresolve/resolve process. For example, GPUs may render one aspect of a surface or tile, e.g., a background, and this data may be stored at the system memory while other aspects of the surface or tile are rendered. This data may then be transferred back to the GPU when rendering another part of a scene, e.g., a character. This process may also be referred to as rendering in multiple paths. Further, GPUs may render different aspects of a scene at different times. For example, the diffuse color of a scene may be rendered, then the spectral color, and then the shadows. So a frame buffer may store data incrementally when the tile or bin is rendered in multiple paths. Also, during the process of rendering each bin or tile, data may be transferred back and forth between the system memory and the GPU memory multiple times.

In certain types of GPUS (e.g., bin rendering GPUs), switching back to a previous rendered surface may involve a number of different operations for each bin. For example, certain data, e.g., color and depth data, for a bin may be moved from a buffer, e.g., a color and depth buffer in the system memory, to GPU internal memory for color and depth. As mentioned above, this process may be referred to as an unresolve process. The bin or tile may then be rendered based on the data, e.g., color and depth data. The data, e.g., color and depth data, may then be moved from GPU internal memory for color and depth to a buffer, e.g., color and depth buffer, in the system memory. As mentioned above, this process may be referred to as a resolve process. In some instances, when unresolving a tile or bin, the entire tile may be transferred from the system memory to the GMEM prior to rendering the tile. After rendering, the entire tile may be resolved from the GMEM to the system memory. So when transferring certain data for a tile in order to render the tile, e.g., to and/or from the system memory and the GMEM, the data for the entire tile may be transferred. As indicated herein, it may take both GPU power and performance in order to transfer data from the system memory to the GMEM, and vice versa, for the unresolve and resolve processes.

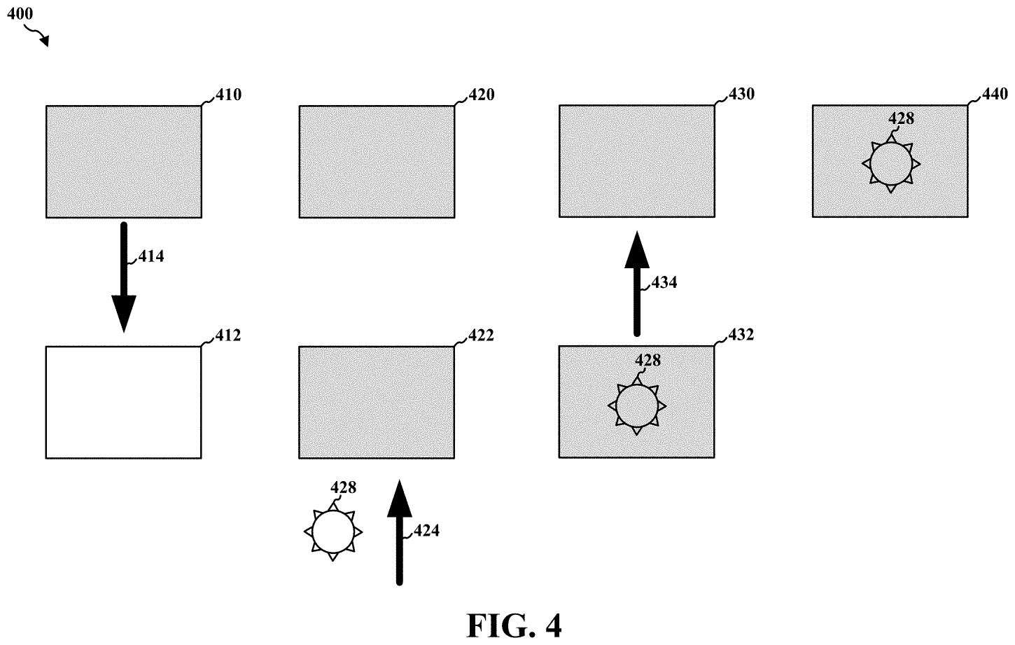

FIG. 4 illustrates an example diagram 400 including a system memory and a GMEM in accordance with one or more techniques of this disclosure. As shown in FIG. 4, diagram 400 includes system memory 410, system memory 420, system memory 430, system memory 440, GMEM 412, GMEM 422, GMEM 432, display content 428, unresolve process 414, rendering 424, resolve process 434. The system memory at 410/420/430/440 may represent the system memory at a GPU or CPU during different times of the unresolve/resolve process. The GMEM 412/422/432 may represent the GMEM at a GPU during different times of the unresolve/resolve process.

As shown in FIG. 4, during unresolve process 414, data or information for a tile may be moved from system memory 410 to GMEM 412. During rendering 424, the display content 428, e.g., a sun, may be rendered for the tile. After rendering, the data or information for the display content 428 may be written or stored to the GMEM 422. After the data or information for the display content 428 has been copied and/or stored at the GMEM 432, the data or information for the display content 428 may be moved from the GMEM 432 to the system memory 430 during the resolve process 434. The data or information for the display content 428 may then be copied or stored to the system memory 440. FIG. 4 displays that in some aspects, a portion of the tile may be updated, e.g., the sun, but the data for the entire tile may be transferred from the system memory to the GMEM and back. By transferring the data for the entire tile, this may waste a lot of memory bandwidth. As a certain portion of the tile is rendered, the entire area of the tile is not rendered. This may also apply to certain rendering operations, e.g., when rendering color and depth memory. In some aspects, during bin rendering, a significant portion of the data or information for a bin or tile may not be written or updated after rendering.

In some aspects of processing different frames in a scene, the amount of perceptible change between successive frames may be relatively unnoticeable (e.g., unnoticeable to the human eye). This may occur when the scene objects in successive frames stay somewhat stable or when a high frame rate or frames-per-second (FPS) is utilized. For instance, at a high frame rate or FPS (e.g., 240 FPS), the amount of perceivable change in pixel data on a frame-to-frame basis may generally be small. In some instances, even when a noticeable change or activity is present between successive frames, this change may be isolated to high density regions of the screen. Accordingly, this may result in other portions of the frame being mostly untouched (e.g., a player model moving within a frame, but the entire background staying relatively still).

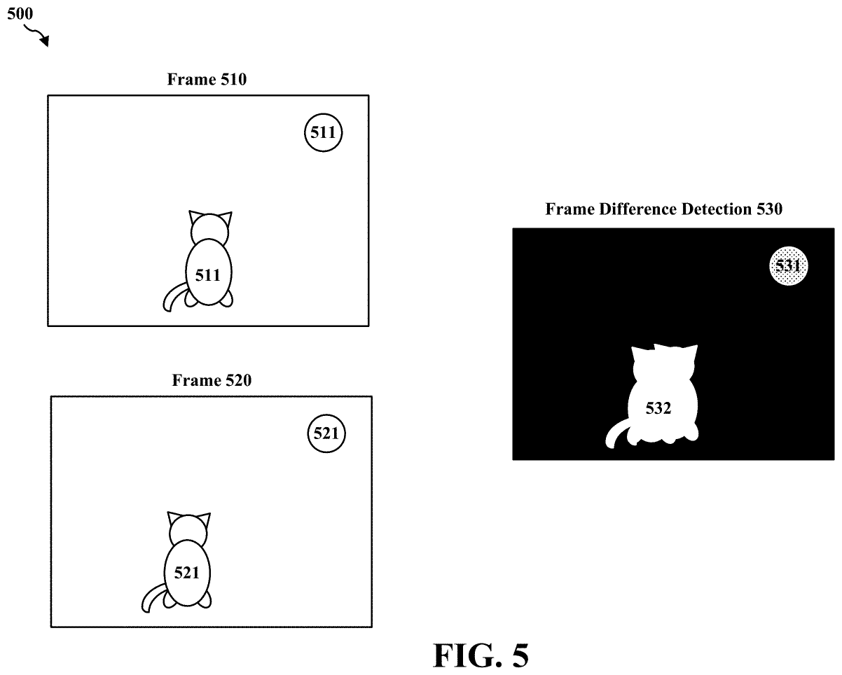

FIG. 5 illustrates diagram 500 including one example of a frame difference detection process. More specifically, diagram 500 in FIG. 5 shows two successive frames and the resulting frame difference detection between the two frames. As shown in FIG. 5, diagram 500 depicts frame 510 including content 511 (e.g., a cat and a moon), frame 520 including content 521 (e.g., a cat and a moon), and frame difference detection 530. FIG. 5 illustrates that frame difference detection 530 includes similar region 531 and different region 532, as calculated based on the differences between the content 511 in frame 510 and the content 521 in frame 520. In some aspects, frame difference detection 530 may compare the pixel values of the content in frame 510 and frame 520. As shown in frame difference detection 530, the content 511 that is a moon is the same as the content 521 that is a moon. Accordingly, the moon regions in frames 510 and 520 are similar to each other, so they correspond to similar region 531 in frame difference detection 530. Also, there is a slight difference in location between the content 511 that is a cat and the content 521 that is a cat. As such, the cat regions in frames 510 and 520 are different from one another, so they correspond to different region 532. Although these cat regions in frames 510 and 520 are different, they are fairly similar in location, so the overlay of one cat in frame difference detection 530 is merely a slight offset from the overlay of the other cat.

In aspects of frame detection, regions of successive frames with a small amount of change (i.e., little to no change) may be detected during different processing stages. For example, changes between regions of successive frames (e.g., regions with a small amount of change) may be detected during the process of live rendering. If these types of regions are detected, then power saving countermeasures or time saving countermeasures may be deployed by a GPU. For instance, special power saving countermeasures or time saving countermeasures may be deployed to prevent hardware resources (e.g., memory bandwidth) from being expended on certain portions of the frames (e.g., low impact portions of the frame).

Some types of detection methods may be utilized to classify successive frames (or portions of successive frames) as similar or identical. However, relying on some detection methods (e.g., traditional hashing methods) to classify successive frames (or portions of successive frames) as strictly identical may yield methods that are too rigid and unforgiving. In some instances, it may be the case that a region with no human-discernable differences exists between successive frames, but there technically may be some small inconsequential differences in pixel value between the frames. Conventional hashing algorithms may consider these regions with small inconsequential differences as being different, and thus eliminate them from candidacy for identical regions.

Additionally, in some aspects, there may be a certain specification or condition regarding the sizes of different blocks in a frame. For instance, there may be a specification or condition regarding uniform block sizes within a frame, which may typically be utilized to perform certain detection methods. For example, a specification or condition regarding uniform block sizes within a frame may typically be utilized to perform traditional hashing methods. This type of specification or condition may further exacerbate a lack of flexibility in the frame detection process. Also, in some aspects, a greater quantity of blocks at a more fine-grained resolution may be needed to detect static elements within regions of high geometric complexity. However, setting the dimensions in frames to be too large may result in a missed detection of these regions. Moreover, setting the dimensions in frames to be too small may also be undesirable, as unnecessary overhead may be introduced in sparsely populated regions of the frame that do not need the same level of granularity as other regions that are more populated. These types of problems may result in any potential power or time savings being unreachable.

Based on the above, it may be beneficial to increase the amount of power savings or time savings in frame similarity detection or frame difference detection. Also, it may be beneficial to allow for greater flexibility or optimization opportunities within frame similarity detection or frame difference detection. In order to do so, it may be beneficial to allow for differently sized frame dimensions within a frame. For instance, it may be beneficial to allow for differently sized blocks within a frame used in frame similarity detection or frame difference detection. Further, it may be beneficial to preserve visual fidelity during the process of frame similarity detection or frame difference detection.

Aspects of the present disclosure may improve the amount of power savings or time savings in frame similarity detection or frame difference detection. In some instances, aspects presented herein may provide greater flexibility or optimization opportunities within frame similarity detection or frame difference detection. Moreover, aspects of the present disclosure may provide differently sized frame dimensions within a frame. For instance, aspects of the present disclosure may allow for differently sized blocks within a frame used in frame similarity detection or frame difference detection. Also, aspects of the present disclosure may preserve visual fidelity during the process of frame similarity detection or frame difference detection. Indeed, the proposed methods herein may be designed to allow for greater optimization opportunities while implicitly preserving visual fidelity within frame similarity detection or frame difference detection.

Aspects presented herein may determine which frame regions in a frame similarity/difference detection process are candidates for a time tradeoff or power tradeoff. Also, the ability to determine which frame regions are candidates for a time or power tradeoff may be achieved through different mechanics. For example, the ability to determine which frame regions are candidates for a time or power tradeoff may be achieved through the programmable organization of a frame into certain blocks of pixels, such as discrete blocks of pixels. The ability to determine which frame regions are candidates for a time or power tradeoff may also be achieved through the encoding of such blocks in a manner that allows for meaningful block-to-block comparison within a frame or successive frames.

In some instances, aspects presented herein may include an amount of flexibility in a blocking model for frame difference detection. The flexibility proposed in this blocking model may be fully customizable, such that each discrete block may be as large as necessary or as small as necessary (e.g., 1 pixel by 1 pixel). Further, each discrete block in the blocking model may be any appropriate or suitable shape or size, such as dimensionally square, rectangular, or the size/shape may be dynamically updated based on a hardware state. Also, the blocking scheme may be either applied statically across the entire frame or applied variably for different parts of the frame. If the blocking scheme is applied variably for different parts of the frame, this may adaptively ensure precision in certain areas of the frame. For instance, if the blocking scheme is applied variably for different parts of the frame, this may adaptively ensure precision in areas of the frame with a high geometric complexity. This may also reduce the overhead in areas of the frame that may be fully characterized with certain types of blocks (e.g., coarse blocks).

Additionally, in some instances, aspects presented herein may include a similarity encoding for each block in a frame that may be generated by leveraging certain types of algorithms, such as block matching algorithms. For instance, a similarity encoding for each block in a frame may be generated by low latency hardware block matching algorithms, e.g., a sum of absolute differences (SAD) algorithm and/or a sum of squared differences (SSD) algorithm. When utilizing these types of algorithms, the underlying pixel data of each block may be preserved. For example, the underlying pixel data of each block may be preserved by executing a block match between a block in question and a reference block, such as a constant global reference block.

In some aspects, the entire frame similarity/difference detection algorithm may be conceptualized through a number of steps. For instance, the frame similarity/difference detection algorithm may be conceptualized by programmatically breaking or dividing a given frame into a number of blocks. Further, the frame similarity/difference detection algorithm may block match each block in a frame against a constant reference block. By doing so, this may save each result as an encoding for that particular block. Also, the frame similarity/difference detection algorithm may, for each block in the next frame, encode the block in the same manner. After the encoding, the detection algorithm may compare this encoding to the encoding of a previous/last frame for that particular block. Moreover, if the encodings are the same (i.e., identical) or within a certain measure of tolerance (i.e., within a difference threshold), the two blocks may be considered to be similar.

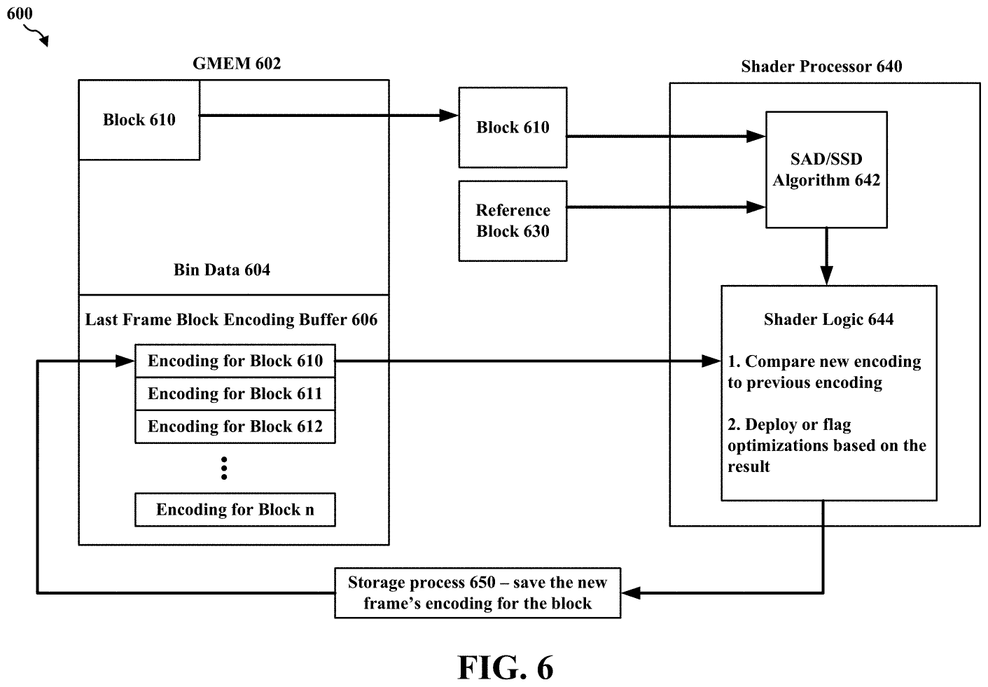

FIG. 6 illustrates diagram 600 of example GPU hardware components including a graphics memory (GMEM) and a shader processor (SP) utilized with a frame detection process. More specifically, diagram 600 in FIG. 6 shows a number of frame blocks and corresponding encodings that are transferred from GMEM 602 to shader processor 640, and vice versa, as part of a frame detection process. As shown in FIG. 6, diagram 600 depicts GMEM 602 including bin data 604 and last frame block encoding buffer 606, as well as shader processor 640 including SAD/SSD algorithm 642 and shader logic 644. In diagram 600, block 610 (e.g., a block in a current frame) may be located in bin data 604 within GMEM 602. As depicted in FIG. 6, aspects presented herein may compare the data for block 610 with reference data for a reference block 630. In some aspects, in order to compare the data for block 610 with the reference data for the reference block 630, the shader processor 640 may execute a sum of absolute differences (SAD) algorithm and/or a sum of squared differences (SSD) algorithm. For instance, shader processor 640 may execute SAD/SSD algorithm 642. The encoding for block 610 in the current frame may then be utilized by shader logic 644 in shader processor 640.

As depicted in FIG. 6, the last frame block encoding buffer 606 may include the encodings for a number of blocks, such as the encoding for block 610, the encoding for block 611, the encoding for block 612, etc., up through the encoding for a certain numbered block (e.g., block n). After the encodings are saved/stored in the last frame block encoding buffer 606, shader logic 644 may compare a new encoding to a previous encoding. For instance, an encoding for a block in a new/current frame (e.g., encoding for block 610 in a new/current frame) may be compared with a corresponding encoding for a block in a previous frame (e.g., encoding for block 610 in a previous frame). Each encoding may be an encoding value that represents data for each block in a frame. Once the new encoding is compared to the previous encoding, the shader logic 644 may deploy or flag certain optimizations based on the comparison result. After the shader logic 644 performs these comparisons and optimizations, during a storage process 650, the encoding for the block in the new/current frame may be saved. For example, the encoding for each block in the new/current frame (e.g., encoding for block 610) may be saved in last frame block encoding buffer 606 in GMEM 602. By doing so, regions/blocks of similarity within successive frames may be identified. The process of identifying regions/blocks of similarity within successive frames may allow GPUs to save time and/or power as part of the frame detection process. In some instances, by identifying regions/blocks of similarity, selectively applying time/power saving operations at a GPU may become trivial.

Aspects of the present disclosure may include a number of benefits or advantages. For instance, aspects presented herein may reduce the amount of data that is stored to a final system memory buffer. In some aspects, blocks that are determined to be similar between successive frames via the aforementioned algorithm may be prevented from being stored out of the GPU to the final system memory buffer. Additionally, aspects presented herein may reduce the amount of memory bandwidth utilized by GPUs. Some applications of the present disclosure may provide a reduction in memory bandwidth usage (e.g., a 70% reduction in memory bandwidth usage) between storing similar frames with no reduction in frame quality. The memory bandwidth savings may increase further (e.g., approaching a 90% reduction in memory bandwidth usage) in some cases where a small amount of frame quality loss may be allowed.

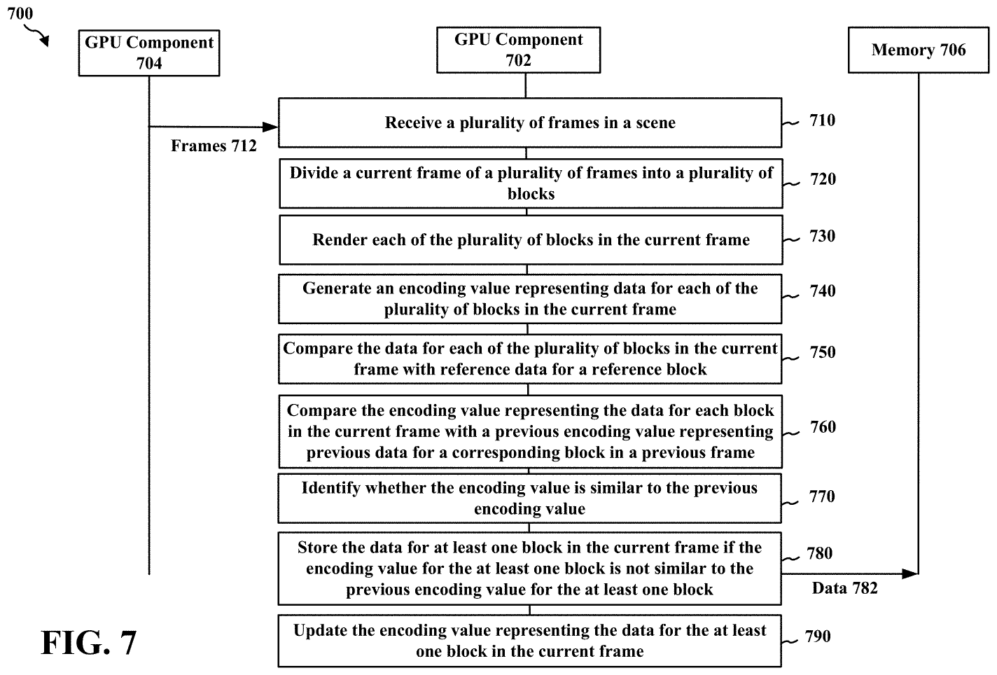

FIG. 7 is a communication flow diagram 700 of graphics processing in accordance with one or more techniques of this disclosure. As shown in FIG. 7, diagram 700 includes example communications between components of a GPU (or other graphics processor), e.g., GPU component 702, GPU component 704, and memory 706 (e.g., system memory, double data rate (DDR) memory, or video memory), in accordance with one or more techniques of this disclosure.

At 710, GPU component 702 may receive, from at least one component in a graphics processing unit (GPU) pipeline, a plurality of frames in a scene (e.g., receive frames 712 from GPU component 704) prior to dividing a current frame into a plurality of blocks.

At 720, GPU component 702 may divide a current frame into a plurality of blocks, the current frame being included in a plurality of frames in a scene, each of the plurality of blocks in the current frame including a set of pixels.

At 730, GPU component 702 may render, upon dividing the current frame into the plurality of blocks, each of the plurality of blocks in the current frame including the set of pixels.

At 740, GPU component 702 may generate, upon dividing the current frame into the plurality of blocks, an encoding value representing data for each of the plurality of blocks in the current frame. In some aspects, the data for each of the plurality of blocks in the current frame may be pixel data.

At 750, GPU component 702 may compare the data for each of the plurality of blocks in the current frame with reference data for a reference block, where the comparison of the data with the reference data is associated with the generation of the encoding value representing the data for each of the plurality of blocks in the current frame. The reference data for the reference block may include at least one of: constant data, comparison constant data, dummy data, or constant noise. The data for each of the plurality of blocks in the current frame may be compared by a shader processor (SP) of a graphics processing unit (GPU). In some aspects, to compare the data for each of the plurality of blocks in the current frame with the reference data for the reference block, the shader processor of the GPU may execute at least one of a sum of absolute differences (SAD) algorithm or a sum of squared differences (SSD) algorithm.

At 760, GPU component 702 may compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene. The previous encoding value representing the previous data for each of the plurality of blocks in the previous frame may be generated prior to the encoding value representing the data for each of the plurality of blocks in the current frame.

At 770, GPU component 702 may identify whether the encoding value representing the data for each of the plurality of blocks in the current frame is similar to the previous encoding value representing the previous data for the corresponding block of the plurality of blocks in the previous frame. The encoding value representing the data for each of the plurality of blocks in the current frame may be identified to be similar to the previous encoding value representing the previous data for the corresponding block of the plurality of blocks in the previous frame if the encoding value is identical to the previous encoding value or if the encoding value is within a difference threshold from the previous encoding value.

At 780, GPU component 702 may store the data for at least one block of the plurality of blocks in the current frame (e.g., store data 782 to memory 706) if the encoding value representing the data for the at least one block is not similar to the previous encoding value representing the previous data for at least one corresponding block of the plurality of blocks in the previous frame. The data for the at least one block of the plurality of blocks in the current frame may be stored in at least one of: system memory, double data rate (DDR) memory, or video memory. The data for the at least one block of the plurality of blocks may not be stored if the encoding value representing the data for the at least one block is similar to the previous encoding value representing the previous data for the at least one corresponding block of the plurality of blocks in the previous frame. The encoding value representing the data for the at least one block may be similar to the previous encoding value representing the previous data for the at least one corresponding block of the plurality of blocks in the previous frame if the encoding value is identical to the previous encoding value or if the encoding value is within a difference threshold from the previous encoding value.

At 790, GPU component 702 may update the encoding value representing the data for the at least one block of the plurality of blocks in the current frame after the data for the at least one block is stored. The updated encoding value representing the data for the at least one block of the plurality of blocks in the current frame may be saved in on-chip memory or graphics memory (GMEM).

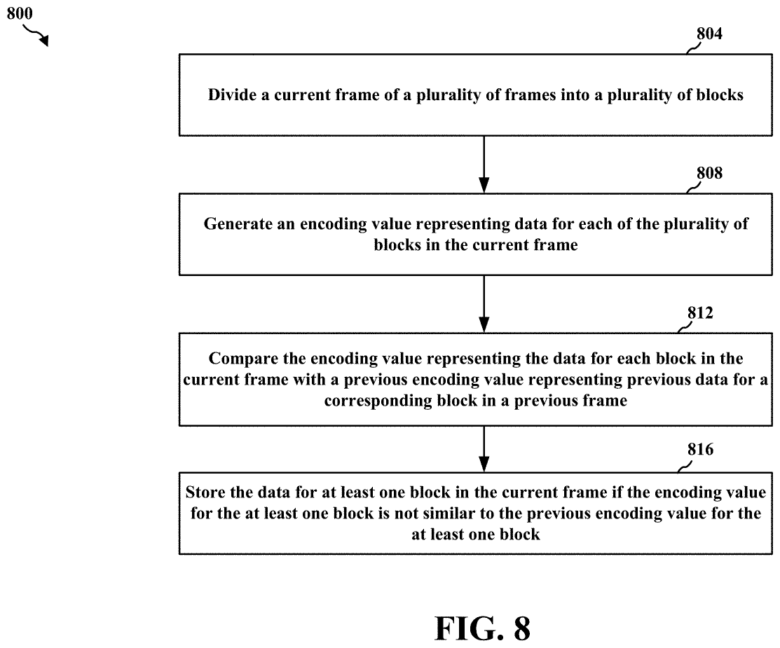

FIG. 8 is a flowchart 800 of an example method of graphics processing in accordance with one or more techniques of this disclosure. The method may be performed by a GPU, such as an apparatus for graphics processing, a graphics processor, a CPU, a wireless communication device, and/or any apparatus that may perform graphics processing as used in connection with the examples of FIGS. 1-7. The methods described herein may provide a number of benefits, such as improving resource utilization and/or power savings.

At 804, the GPU may divide a current frame into a plurality of blocks, the current frame being included in a plurality of frames in a scene, each of the plurality of blocks in the current frame including a set of pixels, as described in connection with the examples in FIGS. 1-7. For example, as described in 720 of FIG. 7, GPU component 702 may divide a current frame into a plurality of blocks, the current frame being included in a plurality of frames in a scene, each of the plurality of blocks in the current frame including a set of pixels. Further, step 804 may be performed by processing unit 120 in FIG. 1.

At 808, the GPU may generate, upon dividing the current frame into the plurality of blocks, an encoding value representing data for each of the plurality of blocks in the current frame, as described in connection with the examples in FIGS. 1-7. For example, as described in 740 of FIG. 7, GPU component 702 may generate, upon dividing the current frame into the plurality of blocks, an encoding value representing data for each of the plurality of blocks in the current frame. Further, step 808 may be performed by processing unit 120 in FIG. 1. In some aspects, the data for each of the plurality of blocks in the current frame may be pixel data.

At 812, the GPU may compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene, as described in connection with the examples in FIGS. 1-7. For example, as described in 760 of FIG. 7, GPU component 702 may compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene. Further, step 812 may be performed by processing unit 120 in FIG. 1. The previous encoding value representing the previous data for each of the plurality of blocks in the previous frame may be generated prior to the encoding value representing the data for each of the plurality of blocks in the current frame.

At 816, the GPU may store the data for at least one block of the plurality of blocks in the current frame if the encoding value representing the data for the at least one block is not similar to the previous encoding value representing the previous data for at least one corresponding block of the plurality of blocks in the previous frame, as described in connection with the examples in FIGS. 1-7. For example, as described in 780 of FIG. 7, GPU component 702 may store the data for at least one block of the plurality of blocks in the current frame if the encoding value representing the data for the at least one block is not similar to the previous encoding value representing the previous data for at least one corresponding block of the plurality of blocks in the previous frame. Further, step 816 may be performed by processing unit 120 in FIG. 1. The data for the at least one block of the plurality of blocks in the current frame may be stored in at least one of: system memory, double data rate (DDR) memory, or video memory. The data for the at least one block of the plurality of blocks may not be stored if the encoding value representing the data for the at least one block is similar to the previous encoding value representing the previous data for the at least one corresponding block of the plurality of blocks in the previous frame. The encoding value representing the data for the at least one block may be similar to the previous encoding value representing the previous data for the at least one corresponding block of the plurality of blocks in the previous frame if the encoding value is identical to the previous encoding value or if the encoding value is within a difference threshold from the previous encoding value.

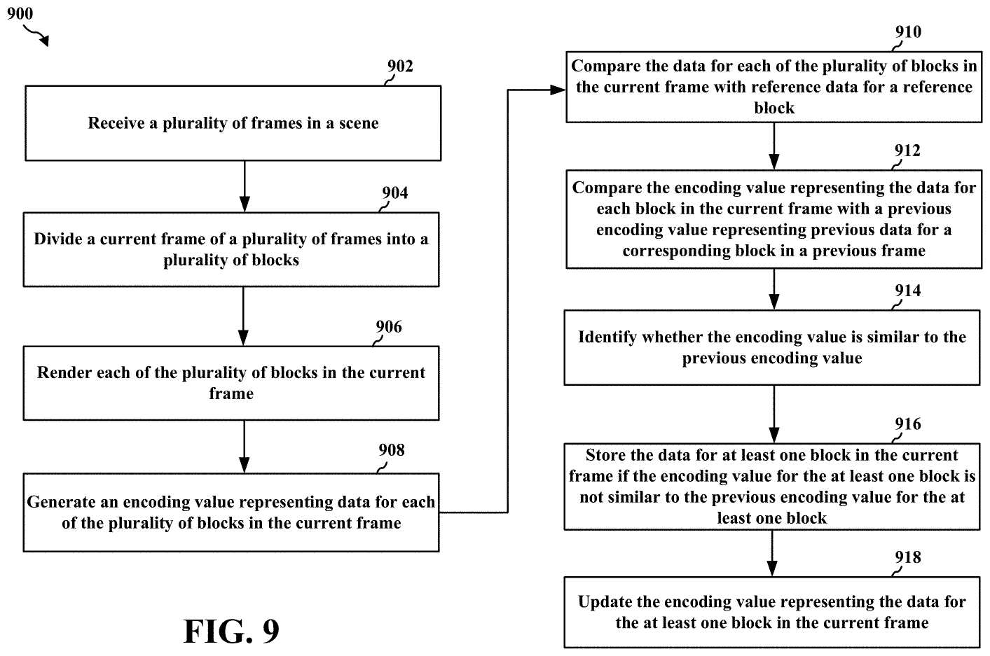

FIG. 9 is a flowchart 900 of an example method of graphics processing in accordance with one or more techniques of this disclosure. The method may be performed by a GPU, such as an apparatus for graphics processing, a graphics processor, a CPU, a wireless communication device, and/or any apparatus that may perform graphics processing as used in connection with the examples of FIGS. 1-7. The methods described herein may provide a number of benefits, such as improving resource utilization and/or power savings.

At 902, the GPU may receive, from at least one component in a graphics processing unit (GPU) pipeline, a plurality of frames in a scene prior to dividing a current frame into a plurality of blocks, as described in connection with the examples in FIGS. 1-7. For example, as described in 710 of FIG. 7, GPU component 702 may receive, from at least one component in a graphics processing unit (GPU) pipeline, a plurality of frames in a scene prior to dividing a current frame into a plurality of blocks. Further, step 902 may be performed by processing unit 120 in FIG. 1.

At 904, the GPU may divide a current frame into a plurality of blocks, the current frame being included in a plurality of frames in a scene, each of the plurality of blocks in the current frame including a set of pixels, as described in connection with the examples in FIGS. 1-7. For example, as described in 720 of FIG. 7, GPU component 702 may divide a current frame into a plurality of blocks, the current frame being included in a plurality of frames in a scene, each of the plurality of blocks in the current frame including a set of pixels. Further, step 904 may be performed by processing unit 120 in FIG. 1.

At 906, the GPU may render, upon dividing the current frame into the plurality of blocks, each of the plurality of blocks in the current frame including the set of pixels, as described in connection with the examples in FIGS. 1-7. For example, as described in 730 of FIG. 7, GPU component 702 may render, upon dividing the current frame into the plurality of blocks, each of the plurality of blocks in the current frame including the set of pixels. Further, step 906 may be performed by processing unit 120 in FIG. 1.

At 908, the GPU may generate, upon dividing the current frame into the plurality of blocks, an encoding value representing data for each of the plurality of blocks in the current frame, as described in connection with the examples in FIGS. 1-7. For example, as described in 740 of FIG. 7, GPU component 702 may generate, upon dividing the current frame into the plurality of blocks, an encoding value representing data for each of the plurality of blocks in the current frame. Further, step 908 may be performed by processing unit 120 in FIG. 1. In some aspects, the data for each of the plurality of blocks in the current frame may be pixel data.

At 910, the GPU may compare the data for each of the plurality of blocks in the current frame with reference data for a reference block, where the comparison of the data with the reference data is associated with the generation of the encoding value representing the data for each of the plurality of blocks in the current frame, as described in connection with the examples in FIGS. 1-7. For example, as described in 750 of FIG. 7, GPU component 702 may compare the data for each of the plurality of blocks in the current frame with reference data for a reference block, where the comparison of the data with the reference data is associated with the generation of the encoding value representing the data for each of the plurality of blocks in the current frame. Further, step 910 may be performed by processing unit 120 in FIG. 1. The reference data for the reference block may include at least one of: constant data, comparison constant data, dummy data, or constant noise. The data for each of the plurality of blocks in the current frame may be compared by a shader processor (SP) of a graphics processing unit (GPU). In some aspects, to compare the data for each of the plurality of blocks in the current frame with the reference data for the reference block, the shader processor of the GPU may execute at least one of a sum of absolute differences (SAD) algorithm or a sum of squared differences (SSD) algorithm.

At 912, the GPU may compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene, as described in connection with the examples in FIGS. 1-7. For example, as described in 760 of FIG. 7, GPU component 702 may compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene. Further, step 912 may be performed by processing unit 120 in FIG. 1. The previous encoding value representing the previous data for each of the plurality of blocks in the previous frame may be generated prior to the encoding value representing the data for each of the plurality of blocks in the current frame.

At 914, the GPU may identify whether the encoding value representing the data for each of the plurality of blocks in the current frame is similar to the previous encoding value representing the previous data for the corresponding block of the plurality of blocks in the previous frame, as described in connection with the examples in FIGS. 1-7. For example, as described in 770 of FIG. 7, GPU component 702 may identify whether the encoding value representing the data for each of the plurality of blocks in the current frame is similar to the previous encoding value representing the previous data for the corresponding block of the plurality of blocks in the previous frame. Further, step 914 may be performed by processing unit 120 in FIG. 1. The encoding value representing the data for each of the plurality of blocks in the current frame may be identified to be similar to the previous encoding value representing the previous data for the corresponding block of the plurality of blocks in the previous frame if the encoding value is identical to the previous encoding value or if the encoding value is within a difference threshold from the previous encoding value.

At 916, the GPU may store the data for at least one block of the plurality of blocks in the current frame if the encoding value representing the data for the at least one block is not similar to the previous encoding value representing the previous data for at least one corresponding block of the plurality of blocks in the previous frame, as described in connection with the examples in FIGS. 1-7. For example, as described in 780 of FIG. 7, GPU component 702 may store the data for at least one block of the plurality of blocks in the current frame if the encoding value representing the data for the at least one block is not similar to the previous encoding value representing the previous data for at least one corresponding block of the plurality of blocks in the previous frame. Further, step 916 may be performed by processing unit 120 in FIG. 1. The data for the at least one block of the plurality of blocks in the current frame may be stored in at least one of: system memory, double data rate (DDR) memory, or video memory. The data for the at least one block of the plurality of blocks may not be stored if the encoding value representing the data for the at least one block is similar to the previous encoding value representing the previous data for the at least one corresponding block of the plurality of blocks in the previous frame. The encoding value representing the data for the at least one block may be similar to the previous encoding value representing the previous data for the at least one corresponding block of the plurality of blocks in the previous frame if the encoding value is identical to the previous encoding value or if the encoding value is within a difference threshold from the previous encoding value.

At 918, the GPU may update the encoding value representing the data for the at least one block of the plurality of blocks in the current frame after the data for the at least one block is stored, as described in connection with the examples in FIGS. 1-7. For example, as described in 790 of FIG. 7, GPU component 702 may update the encoding value representing the data for the at least one block of the plurality of blocks in the current frame after the data for the at least one block is stored. Further, step 918 may be performed by processing unit 120 in FIG. 1. The updated encoding value representing the data for the at least one block of the plurality of blocks in the current frame may be saved in on-chip memory or graphics memory (GMEM).

In configurations, a method or an apparatus for graphics processing is provided. The apparatus may be a GPU, a graphics processor, or some other processor that may perform graphics processing. In aspects, the apparatus may be the processing unit 120 within the device 104, or may be some other hardware within the device 104 or another device. The apparatus, e.g., processing unit 120, may include means for dividing a current frame into a plurality of blocks, the current frame being included in a plurality of frames in a scene, each of the plurality of blocks in the current frame including a set of pixels; means for generating, upon dividing the current frame into the plurality of blocks, an encoding value representing data for each of the plurality of blocks in the current frame; means for comparing the encoding value representing the data for each of the plurality of blocks in the current frame with a previous encoding value representing previous data for a corresponding block of the plurality of blocks in a previous frame, the previous frame occurring prior to the current frame in the plurality of frames in the scene; means for storing the data for at least one block of the plurality of blocks in the current frame if the encoding value representing the data for the at least one block is not similar to the previous encoding value representing the previous data for at least one corresponding block of the plurality of blocks in the previous frame; means for comparing the data for each of the plurality of blocks in the current frame with reference data for a reference block, where the comparison of the data with the reference data is associated with the generation of the encoding value representing the data for each of the plurality of blocks in the current frame; means for identifying whether the encoding value representing the data for each of the plurality of blocks in the current frame is similar to the previous encoding value representing the previous data for the corresponding block of the plurality of blocks in the previous frame; means for updating the encoding value representing the data for the at least one block of the plurality of blocks in the current frame after the data for the at least one block is stored; means for receiving, from at least one component in a graphics processing unit (GPU) pipeline, the plurality of frames in the scene prior to dividing the current frame into the plurality of blocks; and means for rendering, upon dividing the current frame into the plurality of blocks, each of the plurality of blocks in the current frame including the set of pixels.

The subject matter described herein may be implemented to realize one or more benefits or advantages. For instance, the described graphics processing techniques may be used by a GPU, a graphics processor, or some other processor that may perform graphics processing to implement the frame similarity encoding techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize frame similarity encoding techniques in order to improve memory bandwidth efficiency and/or increase processing speed at a GPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing including at least one processor coupled to a memory and configured to: divide a current frame into a plurality of blocks, the current frame being included in a plurality of frames in a scene, each of the plurality of blocks in the current frame including a set of pixels; generate, upon dividing the current frame into the plurality of blocks, an encoding value representing data for each of the plurality of blocks in the current frame; compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene; and store the data for at least one block of the plurality of blocks in the current frame if the encoding value representing the data for the at least one block is not similar to the previous encoding value representing the previous data for at least one corresponding block of the plurality of blocks in the previous frame.

Aspect 2 is the apparatus of aspect 1, where the at least one processor is further configured to: compare the data for each of the plurality of blocks in the current frame with reference data for a reference block, where the comparison of the data with the reference data is associated with the generation of the encoding value representing the data for each of the plurality of blocks in the current frame.

Aspect 3 is the apparatus of any of aspects 1 and 2, where the data for each of the plurality of blocks in the current frame is compared by a shader processor (SP) of a graphics processing unit (GPU).

Aspect 4 is the apparatus of any of aspects 1 to 3, where, to compare the data for each of the plurality of blocks in the current frame with the reference data for the reference block, the shader processor of the GPU executes at least one of a sum of absolute differences (SAD) algorithm or a sum of squared differences (SSD) algorithm.

Aspect 5 is the apparatus of any of aspects 1 to 4, where the reference data for the reference block includes at least one of: constant data, comparison constant data, dummy data, or constant noise.

Aspect 6 is the apparatus of any of aspects 1 to 5, where the at least one processor is further configured to: identify whether the encoding value representing the data for each of the plurality of blocks in the current frame is similar to the previous encoding value representing the previous data for the corresponding block of the plurality of blocks in the previous frame.

Aspect 7 is the apparatus of any of aspects 1 to 6, where the encoding value representing the data for each of the plurality of blocks in the current frame is identified to be similar to the previous encoding value representing the previous data for the corresponding block of the plurality of blocks in the previous frame if the encoding value is identical to the previous encoding value or if the encoding value is within a difference threshold from the previous encoding value.

Aspect 8 is the apparatus of any of aspects 1 to 7, where the at least one processor is further configured to: update the encoding value representing the data for the at least one block of the plurality of blocks in the current frame after the data for the at least one block is stored.

Aspect 9 is the apparatus of any of aspects 1 to 8, where the updated encoding value representing the data for the at least one block of the plurality of blocks in the current frame is saved in on-chip memory or graphics memory (GMEM).

Aspect 10 is the apparatus of any of aspects 1 to 9, where the data for the at least one block of the plurality of blocks is not stored if the encoding value representing the data for the at least one block is similar to the previous encoding value representing the previous data for the at least one corresponding block of the plurality of blocks in the previous frame.

Aspect 11 is the apparatus of any of aspects 1 to 10, where the at least one processor is further configured to: receive, from at least one component in a graphics processing unit (GPU) pipeline, the plurality of frames in the scene prior to dividing the current frame into the plurality of blocks.

Aspect 12 is the apparatus of any of aspects 1 to 11, where the at least one processor is further configured to: render, upon dividing the current frame into the plurality of blocks, each of the plurality of blocks in the current frame including the set of pixels.

Aspect 13 is the apparatus of any of aspects 1 to 12, where the previous encoding value representing the previous data for each of the plurality of blocks in the previous frame is generated prior to the encoding value representing the data for each of the plurality of blocks in the current frame.

Aspect 14 is the apparatus of any of aspects 1 to 13, where the data for each of the plurality of blocks in the current frame is pixel data.

Aspect 15 is the apparatus of any of aspects 1 to 14, where the data for the at least one block of the plurality of blocks in the current frame is stored in at least one of: system memory, double data rate (DDR) memory, or video memory.

Aspect 16 is the apparatus of any of aspects 1 to 15, where the apparatus is a wireless communication device, further including at least one of an antenna or a transceiver coupled to the at least one processor.

Aspect 17 is a method of graphics processing for implementing any of aspects 1 to 16.

Aspect 18 is an apparatus for graphics processing including means for implementing any of aspects 1 to 16.

Aspect 19 is a non-transitory computer-readable medium storing computer executable code, the code when executed by at least one processor causes the at least one processor to implement any of aspects 1 to 16.

What is claimed is:

1. An apparatus for graphics processing, comprising:
a memory; and
at least one processor coupled to the memory and configured to:
divide a current frame into a plurality of blocks, the current frame being included in a plurality of frames in a scene, each of the plurality of blocks in the current frame including a set of pixels;
generate, upon dividing the current frame into the plurality of blocks, an encoding value representing data for each of the plurality of blocks in the current frame;
compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene; and
store the data for at least one block of the plurality of blocks in the current frame if the encoding value representing the data for the at least one block is not similar to the previous encoding value representing the previous data for at least one corresponding block of the plurality of blocks in the previous frame.

2. The apparatus of claim 1, wherein the at least one processor is further configured to:
compare the data for each of the plurality of blocks in the current frame with reference data for a reference block, wherein the comparison of the data with the reference data is associated with the generation of the encoding value representing the data for each of the plurality of blocks in the current frame.

3. The apparatus of claim 2, wherein the data for each of the plurality of blocks in the current frame is compared by a shader processor (SP) of a graphics processing unit (GPU).

4. The apparatus of claim 3, wherein, to compare the data for each of the plurality of blocks in the current frame with the reference data for the reference block, the shader processor of the GPU executes at least one of a sum of absolute differences (SAD) algorithm or a sum of squared differences (SSD) algorithm.

5. The apparatus of claim 2, wherein the reference data for the reference block includes at least one of: constant data, comparison constant data, dummy data, or constant noise.

6. The apparatus of claim 1, wherein the at least one processor is further configured to:
identify whether the encoding value representing the data for each of the plurality of blocks in the current frame is similar to the previous encoding value representing the previous data for the corresponding block of the plurality of blocks in the previous frame.

7. The apparatus of claim 6, wherein the encoding value representing the data for each of the plurality of blocks in the current frame is identified to be similar to the previous encoding value representing the previous data for the corresponding block of the plurality of blocks in the previous frame if the encoding value is identical to the previous encoding value or if the encoding value is within a difference threshold from the previous encoding value.

8. The apparatus of claim 1, wherein the at least one processor is further configured to:
update the encoding value representing the data for the at least one block of the plurality of blocks in the current frame after the data for the at least one block is stored.

9. The apparatus of claim 8, wherein the updated encoding value representing the data for the at least one block of the plurality of blocks in the current frame is saved in on-chip memory or graphics memory (GMEM).

10. The apparatus of claim 1, wherein the data for the at least one block of the plurality of blocks is not stored if the encoding value representing the data for the at least one block is similar to the previous encoding value representing the previous data for the at least one corresponding block of the plurality of blocks in the previous frame.

11. The apparatus of claim 1, wherein the at least one processor is further configured to:
receive, from at least one component in a graphics processing unit (GPU) pipeline, the plurality of frames in the scene prior to dividing the current frame into the plurality of blocks.

12. The apparatus of claim 1, wherein the at least one processor is further configured to:
render, upon dividing the current frame into the plurality of blocks, each of the plurality of blocks in the current frame including the set of pixels.

13. The apparatus of claim 1, wherein the previous encoding value representing the previous data for each of the plurality of blocks in the previous frame is generated prior to the encoding value representing the data for each of the plurality of blocks in the current frame.

14. The apparatus of claim 1, wherein the data for each of the plurality of blocks in the current frame is pixel data.

15. The apparatus of claim 1, wherein the data for the at least one block of the plurality of blocks in the current frame is stored in at least one of: system memory, double data rate (DDR) memory, or video memory.

16. The apparatus of claim 1, wherein the apparatus is a wireless communication device, further comprising at least one of an antenna or a transceiver coupled to the at least one processor.

17. A method of graphics processing, comprising:
dividing a current frame into a plurality of blocks, the current frame being included in a plurality of frames in a scene, each of the plurality of blocks in the current frame including a set of pixels;
generating, upon dividing the current frame into the plurality of blocks, an encoding value representing data for each of the plurality of blocks in the current frame;
comparing the encoding value representing the data for each of the plurality of blocks in the current frame with a previous encoding value representing previous data for a corresponding block of the plurality of blocks in a previous frame, the previous frame occurring prior to the current frame in the plurality of frames in the scene; and
storing the data for at least one block of the plurality of blocks in the current frame if the encoding value representing the data for the at least one block is not similar to the previous encoding value representing the previous data for at least one corresponding block of the plurality of blocks in the previous frame.

18. The method of claim 17, further comprising:
comparing the data for each of the plurality of blocks in the current frame with reference data for a reference block, wherein the comparison of the data with the reference data is associated with the generation of the encoding value representing the data for each of the plurality of blocks in the current frame.

19. The method of claim 18, wherein the data for each of the plurality of blocks in the current frame is compared by a shader processor (SP) of a graphics processing unit (GPU), and wherein, to compare the data for each of the plurality of blocks in the current frame with the reference data for the reference block, the shader processor of the GPU executes at least one of a sum of absolute differences (SAD) algorithm or a sum of squared differences (SSD) algorithm.

20. The method of claim 18, wherein the reference data for the reference block includes at least one of: constant data, comparison constant data, dummy data, or constant noise.

21. The method of claim 17, further comprising:
identifying whether the encoding value representing the data for each of the plurality of blocks in the current frame is similar to the previous encoding value representing the previous data for the corresponding block of the plurality of blocks in the previous frame.

22. The method of claim 21, wherein the encoding value representing the data for each of the plurality of blocks in the current frame is identified to be similar to the previous encoding value representing the previous data for the corresponding block of the plurality of blocks in the previous frame if the encoding value is identical to the previous encoding value or if the encoding value is within a difference threshold from the previous encoding value.

23. The method of claim 17, further comprising:
updating the encoding value representing the data for the at least one block of the plurality of blocks in the current frame after the data for the at least one block is stored, wherein the updated encoding value representing the data for the at least one block of the plurality of blocks in the current frame is saved in on-chip memory or graphics memory (GMEM).

24. The method of claim 17, wherein the data for the at least one block of the plurality of blocks is not stored if the encoding value representing the data for the at least one block is similar to the previous encoding value representing the previous data for the at least one corresponding block of the plurality of blocks in the previous frame.

25. The method of claim 17, further comprising:
receiving, from at least one component in a graphics processing unit (GPU) pipeline, the plurality of frames in the scene prior to dividing the current frame into the plurality of blocks.

26. The method of claim 17, further comprising:
rendering, upon dividing the current frame into the plurality of blocks, each of the plurality of blocks in the current frame including the set of pixels.

27. The method of claim 17, wherein the previous encoding value representing the previous data for each of the plurality of blocks in the previous frame is generated prior to the encoding value representing the data for each of the plurality of blocks in the current frame.

28. The method of claim 17, wherein the data for each of the plurality of blocks in the current frame is pixel data, and wherein the data for the at least one block of the plurality of blocks in the current frame is stored in at least one of: system memory, double data rate (DDR) memory, or video memory.

29. An apparatus for graphics processing, comprising:
means for dividing a current frame into a plurality of blocks, the current frame being included in a plurality of frames in a scene, each of the plurality of blocks in the current frame including a set of pixels;
means for generating, upon dividing the current frame into the plurality of blocks, an encoding value representing data for each of the plurality of blocks in the current frame;
means for comparing the encoding value representing the data for each of the plurality of blocks in the current frame with a previous encoding value representing previous data for a corresponding block of the plurality of blocks in a previous frame, the previous frame occurring prior to the current frame in the plurality of frames in the scene; and
means for storing the data for at least one block of the plurality of blocks in the current frame if the encoding value representing the data for the at least one block is not similar to the previous encoding value representing the previous data for at least one corresponding block of the plurality of blocks in the previous frame.

30. A non-transitory computer-readable medium storing computer executable code for graphics processing, the code when executed by a processor causes the processor to:
divide a current frame into a plurality of blocks, the current frame being included in a plurality of frames in a scene, each of the plurality of blocks in the current frame including a set of pixels;
generate, upon dividing the current frame into the plurality of blocks, an encoding value representing data for each of the plurality of blocks in the current frame;
compare the encoding value representing the data for each of the plurality of blocks in the current frame with a previous encoding value representing previous data for a corresponding block of the plurality of blocks in a previous frame, the previous frame occurring prior to the current frame in the plurality of frames in the scene; and
store the data for at least one block of the plurality of blocks in the current frame if the encoding value representing the data for the at least one block is not similar to the previous encoding value representing the previous data for at least one corresponding block of the plurality of blocks in the previous frame.
